(19) United States
(12) Patent Application Publication
(10) Pub. No.: US 2003/0165195 A1
(43) Pub. Date: Sep. 4, 2003

(54) Block based video processing

(76) Inventors: Roderick Mackenzie Thomson, Summer (NZ); David Melvyn Banks, Liss Hampshire (GB)

Correspondence Address: R Lewis Gable, Cowan Liebowitz & Latman, 1133 Avenue of the Americas, New York, NY, 10036-6799, US

(21) Appl. No.: 10/257,156

(22) PCT Filed: Mar. 26, 2001
(86) PCT No.: PCT/GB01/01328

(30) Foreign Application Priority Data
Apr. 7, 2000 (GB) 00086538
Apr. 7, 2000 (GB) 00086546

(51) Int. Cl. H04N 7/12

(52) U.S. Cl. 375/240.16; 348/700

(57) ABSTRACT

In video processing, a motion vector is identifed for each of a plurality of overlapping picture blocks. Pictures are then shifted in accordance with the motion vectors to provide multiple shifted pictures, and these are combined with weightings derived from the proximity of the associated pixel to the respective blocks.

This invention relates to video processing and particularly to motion compensation of video processes.

It is a well-known technique in video processing, to identify a motion vector for each pixel and to shift pixels in accordance with those vectors. Such motion compensation is of benefit in myriad video processes, of which standards conversion is a good example. A motion compensated process will be expected to perform considerably better than the equivalent linear process, although at a substantial extra cost in terms of hardware complexity or software processing requirement.

It is an object of one aspect of the present invention to provide a method of taking motion into account, which is less complex and involves less processing than full motion compensation, but which nonetheless offers significant improvements over the equivalent linear process.

Accordingly, the present invention consists in one aspect in a method of video processing comprising the steps of identifying a motion vector for each of a plurality of overlapping picture blocks, picture shifting in accordance with said motion vectors to provide multiple shifted pictures and combining said multiple shifted pictures.

Preferably, the multiple shifted pictures are combined with respective weightings derived from the proximity of the associated pixel to the respective blocks.

Advantageously, each pixel lies in four overlapping blocks.

The major difference between a typical motion compensated system and a system according to one form of this invention (which might be termed a “motion-assisted” system) is that, while a motion compensated system has a vector bandwidth similar to the pixel rate; the motion assisted system may have many fewer vectors per field. Each vector can be associated with a relatively large block.

If the images are constructed using only vectors based on large blocks, the resulting images may look very “blocky” or like independent tiles rather one image.

The technique used in one form of this invention to avoid this effect is to construct each point as a mix of four images, which are constructed using the four closest block vectors. The relative distance from the four block centres controls the proportions in which the four images are mixed.

The advantage of this technique is that discontinuities in the vector field result in image blurring rather than image discontinuities at block boundaries. If two adjacent blocks have the same vector then there is no difficulty but when the vector changes between two blocks the resulting pictures are quite different. A conventional block based system will produce an edge or discontinuity at the block boundary which is particularly visible because it is always in the same position on the screen (that is to say: the inherent blocks become very visible). The approach taken in the present invention will cause image “blurring” over the distance from one block centre to the next, which is much less objectionable.

The present invention consists in another aspect in a method of video processing comprising the steps of identifying a picture region, combining pixels in a first direction over that region; and performing a one dimensional correlation process upon said combined pixels to identify a motion vector in a second, orthogonal direction.

Preferably, the method further comprises the steps of combining pixels in said second direction over that region; and performing a one dimensional correlation process upon said combined pixels to identify a motion vector in said first direction.

In one form of the invention, each individual frame of the sequence is split into a number of blocks. Each m by n block is then summed in one dimension to produce either an m by 1 or a 1 by n block. These two blocks are then analysed for motion in one dimension using phase correlation.

The invention will now be described by way of example with reference to the accompanying drawings, in which:

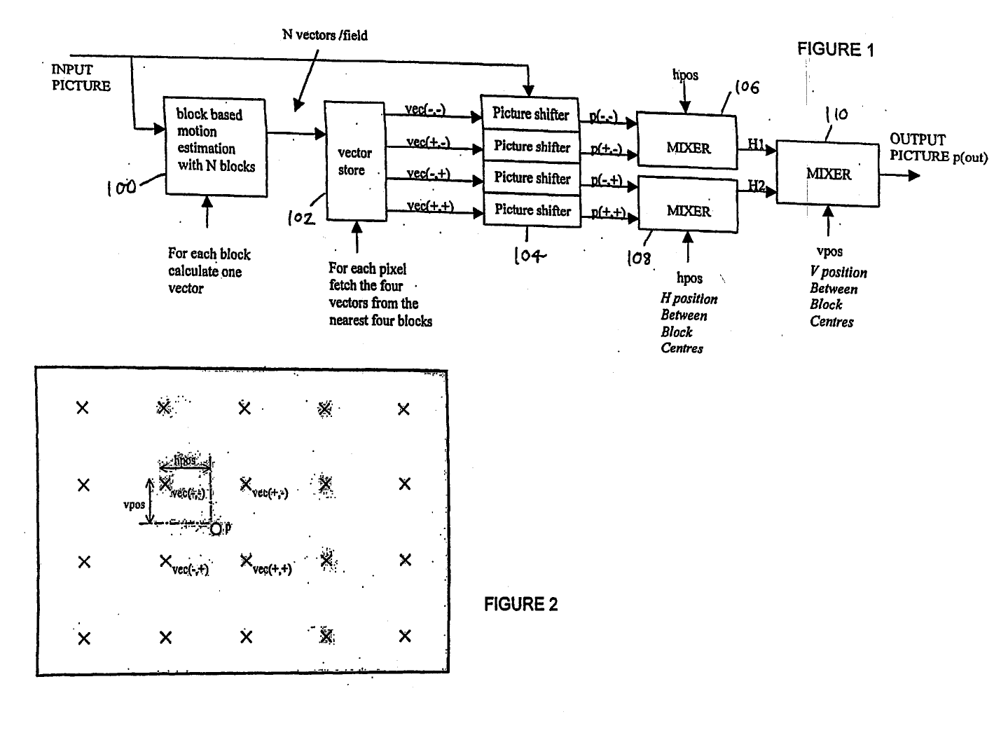

FIG. 1 is a block diagram of apparatus according to an embodiment of the present invention;

FIG. 2 is a diagram illustrating the block structure and mix weightings.

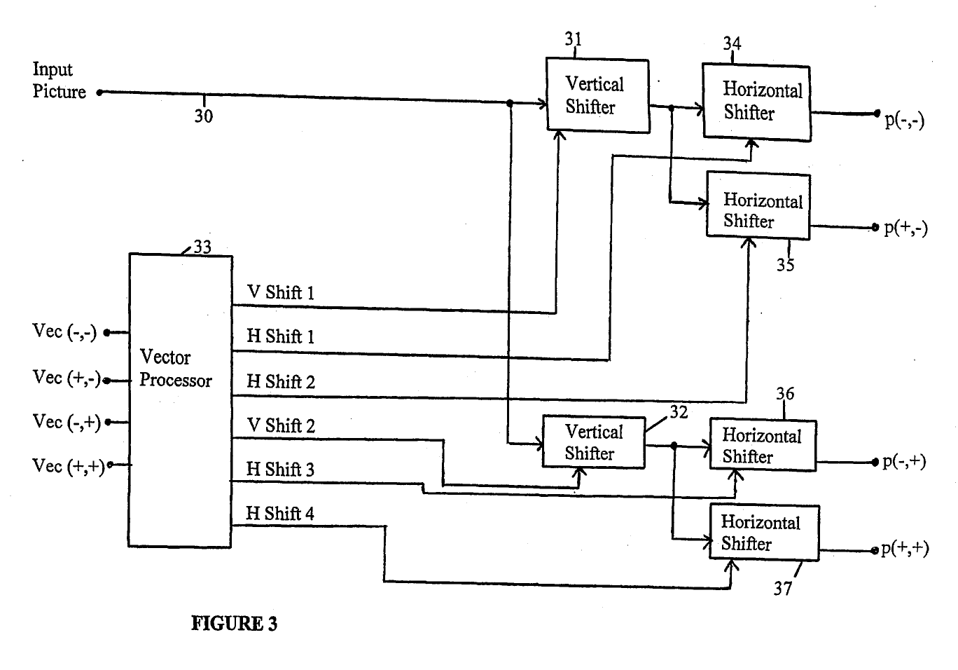

FIG. 3 is a diagram of apparatus according to another embodiment of the invention; and

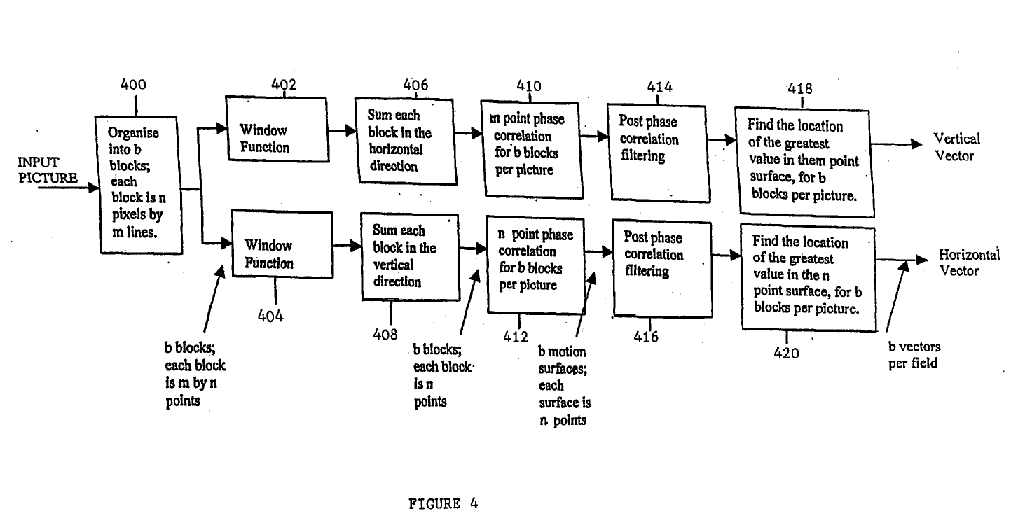

FIG. 4 is a diagram illustrating a further embodiment of the invention.

The following notation is employed in the figures:

X=motion estimation block centre

0=current pixel p

vec(−,−)/vec(+,−)/vec(−,+)/vec(+,+) are the vectors from the four blocks whose block centres are closest to the current pixel p

p(−,−)=image interpolated at p using vec(−,−)

p(−,+)=image interpolated at p using vec(−,+)

p(+,−)=image interpolated at p using vec(+,−)

p(+,+)=image interpolated at p using vec(+,+)

The output pixel p(out)=vpos(H2)+(1-vpos)(HI)

Where; HI=hpos(p(+,−)+(1-hpos)p(−,−) and

H2=hpos(p(+,+)+(1-hpos)p(−,+)

Referring initially to FIG. 1, the input video signal is taken to a block based motion estimator (100). This derives one vector for each block, N vectors per field, utilising phase correlation or simpler motion measurement techniques, which are held in a vector store (102). FIG. 2 shows by way of example an image which has 20 measurement blocks arranged on a 5×4 grid with the block centres marked “X”. It should be noted that the measurement blocks may be overlapping. The vectors vec(−,−), vec(+,−), vec(−,+) and vec(+,+) are then passed from the store (102) to picture shifters (104). The four shifted pictures p(−,−), p(−,+), p(+,−), and p(+,+) are then mixed via blocks 106, 108 and 110 in a two-stage mixing process, first using hpos, and then mixing the two remaining signals using vpos. This produces output picture p(out).

The picture shifts can be regarded as read/write operations with an offset determined by the vector. This offset may be employed on either the read or the write side. Forward or backward vectors can be employed, or combinations thereof.

Each of the picture shifters shown in FIG. 1 may comprise a vertical shifter followed by a horizontal shifter. It is not uncommon for horizontal motion to occur more frequently in the pictures to be processed than vertical motion. In this case a saving in hardware complexity may be achieved by reducing the number of vertical shift circuits.

FIG. 3 shows an example where only two vertical shifters are used. Because there are fewer vertical shifters, the vertical vector field is subsampled horizontally so as to make the number of required shift values correspond to the number of shifters. For example the four vectors of FIG. 2 could be processed as shown below to obtain two vertical shift values and four horizontal shift values.

Let vec(−,−) have horizontal component H(−,−), and vertical component V(−,−), and

vec(+,−) have horizontal component H(+,−), and vertical component V(+,−), etc.

Then:

Vertical Shift 1=½[V(−,−)+V(+,−)]

Vertical Shift 2=½[V(−,+)+V(+,+)]

Horizontal Shift 1=H(−,−)

Horizontal Shift 2=H(+,−)

Horizontal Shift 3=H(−,+)

Horizontal Shift 4=H(+,+)

The use of these six shift values is shown in FIG. 3. The input picture (30) is fed in parallel to two vertical shifters (31) (32). The four vectors from the blocks containing the current pixel are processed as described above in the vector processor (33) so as to derive respective vertical shift values for the two vertical shifters.

The shifted output picture from the vertical shifter (31) is fed in parallel to two horizontal shifters (34) (35). These shifters are fed with horizontal shift values from the vector processor (33) in order to create the pictures p(−,−) and p(+,−) for the mixer shown in FIG. 1.

The output of the vertical shifter (32) is processed in a similar way in the horizontal shifters (36) and (37) to create the other two pictures for the mixer. The output picture mixer has been processed in accordance with motion vectors from four overlapping blocks, but the vertical component of the vectors have been used with reduced resolution to achieve a saving in hardware complexity. Where horizontal motion predominates the subjective quality of the pictures is not adversely affected.

The mixing can of course be conducted in other ways and the relative weighting can take into account other considerations such as the confidence or estimated error in each vector.

Referring finally to FIG. 4, an input video signal is first organised (400) into b blocks; each block is n pixels by m lines. In one example, there are 63 blocks of 64×64 points. These are summed vertically to produce 63 blocks of 64 points. The blocks are 100% overlapping.

In separate horizontal and vertical paths, these blocks are windowed (402, 404) and summed (406, 408) in one direction. “m” and “n” point phase correlations are then conducted (410, 412) for b blocks per picture and the resulting correlation surfaces are then filtered (414, 416). Peaks are then detected (418, 420).

The horizontal and vertical vectors may be used separately or alternatively combined vectorally before use.

The post correlation filtering is optional and is used to increase the reliability of resulting vectors. In one embodiment adjacent blocks are filtered in the H ,V and temporal direction.

The windowing and summing functions could be replaced by other means for combining pixels in one direction. It is preferable to take steps to remove block edge effects and it may sometimes be preferable to weight the sum or other combination to give priority to pixels close to the block centre.

Whilst phase correlation is a particularly useful technique, other and perhaps simpler forms of correlation could alternatively be employed, such as block matching. A gradient approach could also be employed.

In certain applications it will be sufficient to sum in the vertical direction only and to detect only horizontal motion components. It is usually the horizontal motion components that cause the most objectionable motion artefacts in a linear process. In other applications, the horizontal and vertical processing will be time-multiplexed in common hardware.

Processing according to the present invention lends itself particularly well to software implementation or implementation in generic or video-specific digital signal processors.

These techniques can be applied to standards conversion but would be equally applicable in other areas where motion detection is useful. These include prediction based compression systems, interpolators and noise reducers.

It should be understood that this invention has been described by way of examples only and that numerous modifications are possible without departing from the scope of the invention. For example, certain embodiments may make use not merely of the horizontal and vertical components of the vectors, but of further components in other dimensions. For example, one such further dimension would be information regarding depth or distance into the picture, as considered in various special effects systems, and standards such as MPEG4.

1. A method of video processing comprising the steps of identifying a motion vector for each of a plurality of overlapping picture blocks, picture shifting in accordance with said motion vectors to provide multiple shifted pictures and combining said multiple shifted pictures.

2. A method according to claim 1, in which said multiple shifted pictures are combined with respective weightings derived from the proximity of the associated pixel to the respective blocks.

3. A method according to claim 1, in which each pixel lies in four overlapping blocks.

4. A method according to any of the preceding claims, further comprising picture shifting in stages, each stage making a shift in a direction orthogonal to the other stages.

5. A method according to claim 4, wherein a different number of shifts is performed in at least one orthogonal direction.

6. A method of video processing comprising the steps of identifying a picture region, combining pixels in a first direction over that region; and performing a one dimensional correlation process upon said combined pixels to identify a motion vector in a second, orthogonal direction.

7. A method according to claim 6, further comprises the steps of combining pixels in said second direction over that region; and performing a one dimensional correlation process upon said combined pixels to identify a motion vector in said first direction.

8. A method according to claim 6 or claim 7, wherein the step of combining comprises the step of summing.

9. A method according to claim 8, wherein the sum is a weighted sum.

10. A method according to claim 8 or claim 9, wherein the step of combining further comprises the step of windowing.

11. A method according to any one of the preceding claims, in which each picture is split into a number of m by n blocks with each m by n block being summed in one dimension to produce either an m by 1 or a 1 by n block.

12. A method according to claim 11, in which each pixel lies in four overlapping blocks.

13. A method according to any one of the preceding claims, wherein the correlation process comprises phase correlation.
